(19) United States
(12) Patent Application Publication
(10) Pub. No.: US 2014/0173352 A1
(43) Pub. Date: Jun. 19, 2014

(54) COMPUTING DEVICE AND METHOD OF CHECKING BURNED-IN FILES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: WEI PANG, Shenzhen (CN); YANG LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/102,640

(22) Filed: Dec. 11, 2013

(30) Foreign Application Priority Data
Dec. 14, 2012 (CN) 2012105435354

(51) Int. Cl. G06F 11/273

(52) U.S. Cl. CPC G06F 11/273
USPC 714/37

(57) ABSTRACT

In a method to check burned-in files, a file is obtained from a storage device and a checksum value of the file is computed. A burning-in check system is integrated into the file, and then the file is burned-in a complex programmable logic device (CPLD) chip. The checksum value of the file is outputted from a first pin of the CPLD chip to a second pin of the CPLD chip, the checksum value outputted from the second pin is compared with the computed checksum value, to check if the file has been burned-in correctly, and a checking results of whether the file has been burned-in the CPLD chip correctly is send to an output device by the burning-in check system. The output device then outputs the checking results using a preset output mode.

### BACKGROUND

1. Technical Field

Embodiments of the present disclosure relate to data checking devices and methods, and more particularly, to a computing device and method of checking burned-in files.

2. Description of Related Art

A complex programmable logic device (CPLD) is an electronic component used to build reconfigurable digital circuits. Unlike a logic gate, which has a fixed function, a CPLD has an undefined function at the time of manufacture. Before the CPLD can be used in a circuit, it must be programmed, that is, configured. Incorrect programming of the CPLD could result in the CPLD being unusable. Therefore there is room for improvement in the art.

### BRIEF DESCRIPTION OF THE DRAWINGS

FIG. 1 is a block diagram of one embodiment of a computing device which comprises a burning-in check system.

FIG. 2 is a block diagram of one embodiment of function modules of the burning-in check system.

FIG. 3 is a flowchart of one embodiment of method of checking burned-in files.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

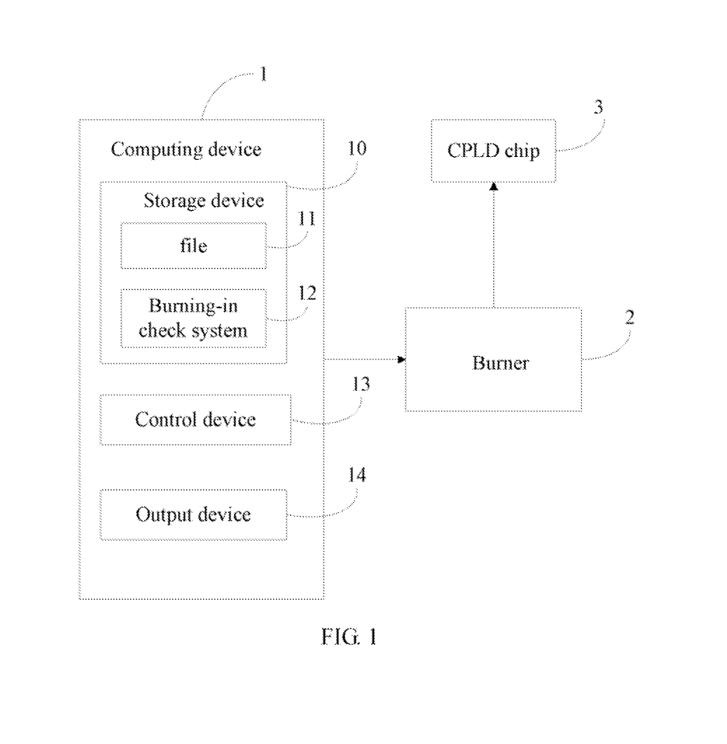

FIG. 1 is a schematic diagram of one embodiment of a computing device 1 which comprises a burning-in check system 12. The computing device 1 may be a computer, or a server, for example. The computing device 1 comprises a storage device 10, a control device 13, and an output device 14. The burning-in check system 12 is stored in the storage device 10. The storage device 10 further stores a file 11. The file 11 comprises data that needs to be burned-in a complex programmable logic device (CPLD) chip 3 using a burner 2. The computing device 1 connects with the burner 2 via a parallel port, a serial port (COM 1 or COM 2), or a universal serial bus (USB) port of the computing device 1, and controls the burner 2 to burn-in the file 11 into the CPLD chip 3.

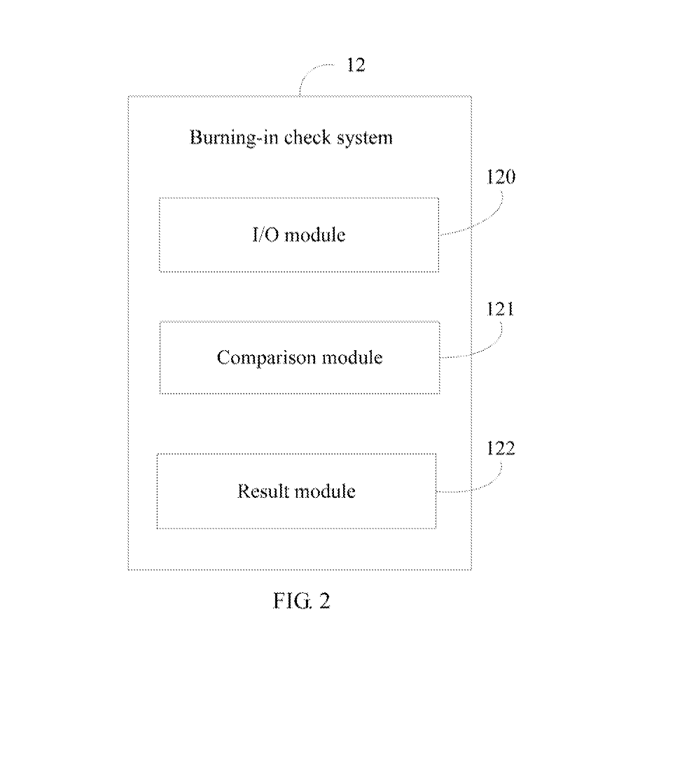

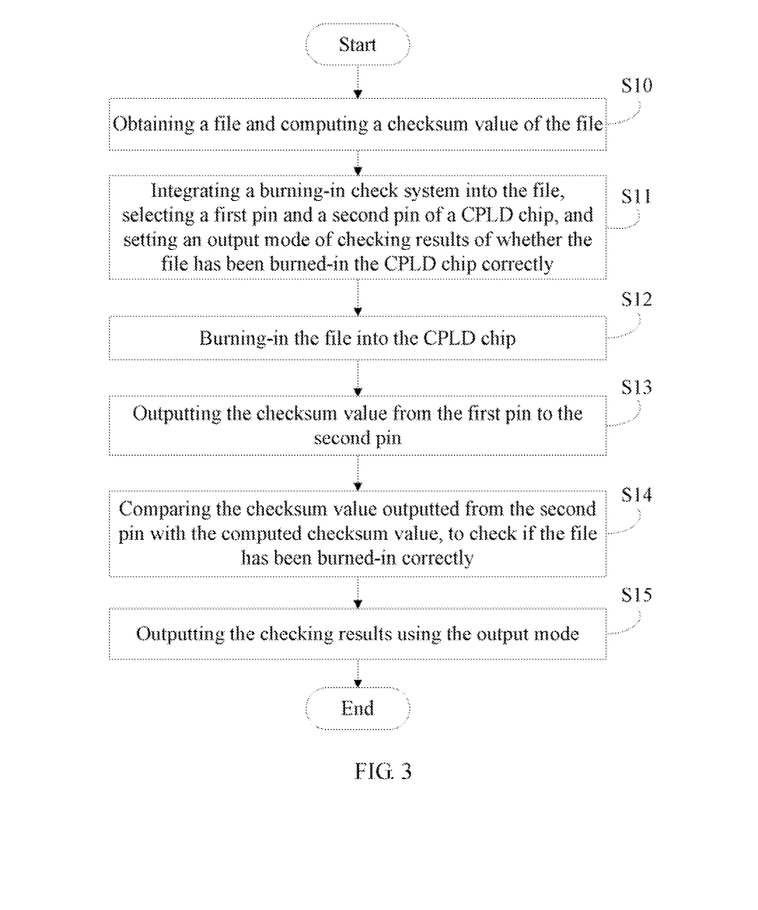

The burning-in check system 12 comprises a number of function modules (see FIG. 2) that include computerized codes in the form of one or more computer-readable programs that are stored in a non-transitory computer-readable storage medium (e.g., the storage device 10) and executed by at least one processor (i.e., the control device 13) of the computing device 1, and provide at least the functions needed to execute steps illustrated in FIG. 3 below.

The storage device 10 can comprise some type(s) of non-transitory computer-readable storage medium, such as a hard disk drive, a compact disc, a digital video disc, or a tape drive.

The control device 13 can comprise a processor, a microprocessor, an application-specific integrated circuit (ASIC), and a field programmable gate array (FPGA), for example.

The output device 14 may be a light emitting diode (LED) device indicating if the file 11 has been burned-in the CPLD chip 3 correctly.

FIG. 2 is a block diagram of one embodiment of function modules of the burning-in check system 12. In one embodiment, the function modules comprise an I/O module 120, a comparison module 121, and a result module 122. Details of the functions of the function modules 120-122 are described the following referring to FIG. 3.

FIG. 3 is a flowchart of one embodiment of method of checking burned-in files. The method is executed by the control device 13 of the computing device 1. Depending on the embodiment, additional steps in FIG. 3 may be added, others removed, and the ordering of the steps may be changed.

In step S10, the control device 13 obtains the file 11 from the storage device 10 and computes a checksum value of the file 11. The checksum value is used to check whether the file 11 has been burned-in the CPLD chip 3 correctly, which is calculated according to each data bit of the file 11.

In step S11, the control device 13 integrates the burning-in check system 12 into the file 11, selects a first pin and a second pin of the CPLD chip 3, and presets output modes of checking results of whether the file 11 has been burned-in the CPLD chip 3 correctly. In one embodiment, the output modes may comprise that when the file 11 has been burned-in the CPLD chip 3 correctly, the output device 14, such as the LED device emits green lights, and when the file 11 has been burned-in the CPLD chip 3 incorrectly, the LED device emits red lights.

In step S12, the control device 13 controls the burner 2 to burn-in the file 11 that is integrated with the burning-in check system 12 into the CPLD chip 3.

In step S13, the I/O module 120 outputs the checksum value of the file 11 from the first pin of the CPLD chip 3 to the second pin of the CPLD chip 3.

In step S14, the comparison module 121 compares the checksum value outputted from the second pin with the checksum value computed by the control device 13, to check if the file 11 has been burned-in correctly. In one embodiment, when the checksum value outputted from the second pin is the same as the checksum value computed by the control device 13, the file 11 has been burned-in correctly. Otherwise, when the checksum value outputted from the second pin is different from the checksum value computed by the control device 13, the file 11 has been burned-in incorrectly.

In step S15, the result module 122 outputs checking results of whether the file 11 has been burned-in the CPLD chip 3 correctly to the output device 14 using the preset output mode.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computing device, comprising:
an output device;
a storage device that stores a file and a burning-in check system;
a control device that computes a checksum value of the file, integrates the burning-in check system into the file, and controls a burner to burn-in the file into a complex programmable logic device (CPLD) chip;
the burning-in check system comprises one or more programs which when executed by the control device, causes the control device chip to:
output the checksum value of the file from a first pin of the CPLD chip to a second pin of the CPLD chip;
compare the checksum value outputted from the second pin with the checksum value computed by the control device, to check if the file has been burned-in correctly; and
output checking results of whether the file has been burned-in the CPLD chip correctly to the output device using a preset output mode.

2. The computing device according to claim 1, wherein the output device comprises a light emitting diode (LED) device.

3. The computing device according to claim 2, wherein the preset output modes comprise that the LED device emits green lights when the file has been burned-in the CPLD chip correctly, and the LED device emits red lights when the file has been burned-in the CPLD chip incorrectly.

4. The computing device according to claim 1, wherein the file has been burned-in correctly upon condition that the checksum value outputted from the second pin is the same as the checksum value computed by the control device, and the file has been burned-in incorrectly upon condition that the checksum value outputted from the second pin is different from the checksum value computed by the control device.

5. A method of checking burned-in files, the method being performed by execution of program codes by processors, and comprising:
obtaining a file from a storage device and computing a checksum value of the file;
integrating a burning-in check system into the file;
controlling a burner to burn-in the file that integrated with the burning-in check system into a complex programmable logic device (CPLD) chip;
outputting the checksum value of the file from a first pin of the CPLD chip to a second pin of the CPLD chip by the burning-in check system;
comparing the checksum value outputted from the second pin with the computed checksum value, to check if the file has been burned-in correctly; and
outputting checking results of whether the file has been burned-in the CPLD chip correctly to an output device using a preset output mode.

6. The method according to claim 5, wherein the output device comprises a light emitting diode (LED) device.

7. The method according to claim 6, wherein the preset output modes comprise LED device emits green lights when the file has been burned-in the CPLD chip correctly, and the LED device emits red lights when the file has been burned-in the CPLD chip incorrectly.

8. The method according to claim 5, wherein the file has been burned-in correctly upon condition that the checksum value outputted from the second pin is the same as the checksum value computed by the control device, and the file has been burned-in incorrectly upon condition that the checksum value outputted from the second pin is different from the checksum value computed by the control device.

9. A non-transitory storage medium having stored thereon instructions that, when executed by processers of at least one processor, causes the processor to perform a method of checking burned-in files, wherein the method comprises:
obtaining a file from a storage device and computing a checksum value of the file;
integrating a burning-in check system into the file;
controlling a burner to burn-in the file that integrated with the burning-in check system into a complex programmable logic device (CPLD) chip;
outputting the checksum value of the file from a first pin of the CPLD chip to a second pin of the CPLD chip by the burning-in check system;
comparing the checksum value outputted from the second pin with the computed checksum value, to check if the file has been burned-in correctly; and
outputting checking results of whether the file has been burned-in the CPLD chip correctly to an output device using a preset output mode.

10. The non-transitory storage medium according to claim 9, wherein the output device comprises a light emitting diode (LED) device.

11. The non-transitory storage medium according to claim 10, wherein the preset output modes comprise that LED device emits green lights, when the file has been burned-in the CPLD chip correctly, and the LED device emits red lights when the file has been burned-in the CPLD chip incorrectly.

12. The non-transitory storage medium according to claim 9, wherein the file has been burned-in correctly upon condition that the checksum value outputted from the second pin is the same as the checksum value computed by the control device, and the file has been burned-in incorrectly upon condition that the checksum value outputted from the second pin is different from the checksum value computed by the control device.
